(19) United States
(12) Patent Application Publication
(10) Pub. No.: US 2003/0184089 A1
(43) Pub. Date: Oct. 2, 2003

(54) Quick connector

(76) Inventors: Akira Takayanagi, Aichi-ken (JP); Yoshimitsu Ishida, Aichi-ken (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/401,810

(22) Filed: Mar. 28, 2003

(30) Foreign Application Priority Data
Mar. 29, 2002 (JP) 2002-095795

(51) Int. Cl. F16L 39/00

(52) U.S. Cl. 285/319

(57) ABSTRACT

An inner peripheral surface of a tube connecting portion of a tubular connector housing is divided into a first receiving portion on one axial side and a second receiving portion on an opposite axial side by an inwardly directed annular parting projection. A first O-ring of one axial side and a second O-ring of an opposite axial side are disposed with intervening a collar therebetween on an opposite axial side in the first receiving portion. The first O-ring is made of FKM and the second O-ring is also made of FKM. A third O-ring is disposed on one axial side in the second receiving portion. The third O-ring is also made of FKM.

### BACKGROUND OF THE INVENTION

The present invention relates to a quick connector to be adapted for assembly in a fuel piping, for example, a fuel piping of an automobile, more specifically, to sealing means to provide a seal between a pipe and a connector housing.

In a gasoline fuel piping structure, for example, a gasoline fuel piping structure of an automobile, a quick connector (A) as shown in FIG. 11 is used for joining a tube to a pipe. The quick connector (A) has a tubular connector housing (B) and a retainer (C) fitted in the tubular connector housing (B). The tubular connector housing (B) is provided with a tube connecting portion (D) on one axial side thereof and a pipe inserting portion (E) on an opposite axial side thereof, and the pipe inserting portion (E) has an projection receiving portion (F) on an opposite axial side thereof wherein the retainer (C) is fitted. A pipe is relatively inserted in the pipe inserting portion (E) from an insertion opening on an opposite axial end of the tubular connector housing (B), the pipe inserting portion (E) or the projection receiving portion (F) so as to snap-fit in the quick connector (A), and thereby the quick connector (A) is connected to the pipe. As shown in FIG. 12, a pipe (G) to be connected to the quick connector (A) is formed with an inserting end portion (H) on one axial side thereof, and the inserting end portion (H) of the pipe (G) is provided with an annular engagement projection (I) on outer peripheral surface thereof. The inserting end portion (H) of the pipe (G) is inserted in the pipe inserting portion (E) of the tubular connector housing (B), the annular engagement projection (I) snap-engages with the retainer (C), and thereby the pipe (G) snap-fits in the quick connector (A).

The pipe inserting portion (E) has a seal holding portion (J) formed smaller in diameter than the projection receiving portion (F) on one axial side from the projection receiving portion (F) thereof. Sealing means (K) is disposed in the seal holding portion (J) on one axial side thereof to provide a seal between the pipe inserting portion (E) and the inserting end portion (H) of the pipe (G). The sealing means (K) comprises annular sealing member (L) made of elastic material, which prevents gasoline from leaking out between the tubular connector housing (B) and the pipe (G).

Meanwhile, an annular sealing member adapted to such sealing means is preferably made of elastic material of low gasoline fuel permeability to deal with environmental problems by reducing gasoline fuel permeation amount from a quick connector. Therefore, if sealing means is constructed by one annular sealing member, fluoro-rubber (FKM), acrylonitrile-butadiene rubber (NBR), acrylonitrile-butadiene rubber/polyvinyl chloride blend rubber (NBR/PVC) or fluoro-rubber/fluoro-silicone-rubber blend rubber (FKM/FVMQ) is used for the annular sealing member in many cases. On the other hand, as shown specifically in FIGS. 11 and 12, if the sealing means (K) is constructed by two annular sealing members (L), (L) disposed axially in side by side relation, the annular sealing member (L) of one axial side to be contacted directly with gasoline is typically made of FKM or FKM/FVMQ in view of gasoline fuel impermeability or low gasoline fuel permeability, and the annular sealing member (L) of an opposite axial side is typically made of fluoro-silicone-rubber (FVMQ), NBR or NBR/PVC in view of low-temperature resistant property.

However, even in this construction, gasoline fuel permeation amount from a quick connector is still high compared to that on other portions in fuel piping system. Considering current situation where regulations become increasingly tighten against permeation of gasoline from fuel piping system in an automobile, gasoline fuel impermeability of the quick connector should be further improved. It is considered that gasoline fuel impermeability of the quick connector is effectively improved by further reducing gasoline fuel permeation amount through the sealing means.

In order to reduce gasoline fuel permeation amount through the sealing means, it may be considered that an annular sealing member of low gasoline permeability is formed in round in cross-section and large in cross-sectional diameter, or an annular sealing member of low gasoline permeability is formed in round shape compressed in radial direction in cross-section. Thus configured annular sealing member is formed larger in an axial direction. However, if an annular sealing member has too large diameter in cross-section, frictional resistance becomes too high at insertion of a pipe, and thereby insertion work is adversely affected. Also, if an annular sealing member of gasoline impermeability is formed larger axially in cross-section, it only takes somewhat longer time for gasoline fuel to permeate through the annular sealing member. Therefore, thus configured sealing means does not bring about substantial reduction in gasoline fuel permeation amount.

### SUMMARY OF THE INVENTION

Accordingly, it is an object of the present invention to provide a quick connector having sealing means to reduce gasoline fuel permeation amount sufficiently.

In order to achieve a foregoing object, there is provided a novel quick connector for gasoline fuel path to be connected with a pipe including an inserting end portion provided with an annular engagement projection, for example, on one axial side thereof.

The quick connector has a tubular connector housing provided with a tube connecting portion on one axial side thereof and a projection receiving portion to receive the annular engagement projection of the pipe on an opposite axial side thereof. The quick connector also has retainer means provided for the projection receiving portion and configured so as to snap-engage with the annular engagement projection of the pipe when the inserting end portion of the pipe is inserted in the tubular connecting housing from an insertion opening on an opposite axial end of the projection receiving portion. The quick connector further has sealing means disposed on one axial side from the projection receiving portion in the tubular connector housing to provide a seal between the tubular connector housing and one axial side from the annular engagement projection of the inserting end portion provided on the pipe. The sealing means includes a first annular sealing member made of FKM and a second annular sealing member also made of FKM located on an opposite axial side from the first annular sealing member in the tubular connector housing. The first annular sealing member and the second annular sealing member are disposed properly axially spaced relation with one another (typically with intervening a spacer therebetween) in the tubular connector housing.

The tubular connector housing may be made of resin or metal. A retainer, which is configured to be fitted in the projection receiving portion of the tubular connector housing, may be adapted for retainer means. The retainer is fitted in the projection receiving portion of the tubular connector housing, for example, with engaging in a pair of engagement windows formed on the projection receiving portion. An engagement slit may be formed on one axial end portion of the retainer, the annular engagement projection of the pipe snap-engages in the engagement slit, and thereby connection has been completed between the pipe and the connector. A retainer, which is configured to be fitted on an outer peripheral surface of the projection receiving portion of the tubular connector housing so as to embrace therearound, also may be adapted for retainer means. The retainer may be formed generally in C-shape or horse-shoe shape and provided with a pair of leg portions, for example, as wire retainer or wire clip type retainer. The retainer is fitted on an outer peripheral surface of the projection receiving portion of the tubular connector housing with the leg portions seated in a pair of engagement windows formed like slit on the projection receiving portion, or in any other manner. The leg portions of the retainer may project inside of the projection receiving portion through the engagement windows or the slit-like engagement windows on the projection receiving portion. Here, the leg portions or inwardly directed engagement portions formed on ends of the leg portions snap-engage with the annular engagement projection of the pipe, and thereby connection has been completed between the pipe and the quick connector.

The sealing means of the quick connector according to the present invention includes a first annular sealing member made of FKM and a second annular sealing member also made of FKM in the tubular connector housing. The fist annular sealing member is located on one axial side, namely on one axial side from the second annular sealing member, and the second annular sealing member is located on an opposite axial side from the first annular sealing member in the tubular connector housing. FKM has very excellent or superior gasoline impermeability or very excellent gasoline fuel impermeability as well as excellent water-proof and dust proof properties. Further, the first annular sealing member made of FKM and the second annular sealing member made of FKM are disposed properly axially spaced relation with one another. Therefore, the first annular sealing member of high gasoline fuel impermeability contacts directly with gasoline fuel in gasoline fuel piping, and restrict gasoline permeation amount. A bit of gasoline, which has permeated through the first annular sealing member of high gasoline impermeability, is received between the first annular sealing member and the second annular sealing member as gasoline vapor. Gasoline, which is received between the first annular sealing member and the second annular sealing member as gasoline vapor, extremely lowers permeability with respect to the second annular sealing member. Moreover, as the second annular sealing member has also high gasoline impermeability, there could be little amount of gasoline vapor being permitted to permeate through the second annular sealing member, if any.

The sealing means of the quick connector according to the present invention may further include a third annular sealing member located on an opposite axial side from the second annular sealing member, and properly axially spaced with respect to the second annular sealing member (typically with intervening a spacer therebetween) in the tubular connector housing. Material of the third annular sealing member may be selected in view of gasoline fuel impermeability or in other view points. In order to further improve gasoline fuel impermeability of the sealing means, the third annular sealing member should be made of material having impermeability with respect to a very slight amount of gasoline vapor, which is received through the second annular sealing member between the third annular sealing member and the second annular sealing member. Therefore, it is effective to adapt FKM also for the third annular sealing member. Thus configured sealing means enables to prevent gasoline fuel substantially completely from permeating therethrough. In addition, FKM has very excellent or superior ozone resistant property. As the third annular sealing member is exposed to the air in many cases, FKM is an effective material for the third annular sealing member in this point of view as well.

By the way, FKM is superior in gasoline fuel impermeability and ozone resistant property, but is inferior in low-temperature resistant property or low-temperature property as shown in Table 1 which indicates properties of each material. In case that FKM is used for the third annular sealing member, there is a fear that the first to the third annular sealing members come short of elasticity, and thereby sealing property of the sealing means is lowered in cold climate regions. Accordingly, in order to provide the sealing means with low-temperature resistant property as well as gasoline fuel impermeability, material for the third annular sealing member is selected in view of low-temperature resistant property. As for such material, FVMQ, NBR, NBR/PVC, ethylene-propylene-diene rubber (EPDM) or thermoplastic olefin TPO) may be selected. As shown in Table 1, FVMQ and EPDM are superior in low-temperature resistant property as well as excellent in water proof and dust proof properties. Although FVMQ and EPDM are also excellent in ozone resistant property, if FVMQ is used for the third annular sealing member, more excellent ozone resistant property is given to the sealing means by superior ozone resistant property of FVMQ, and at the same time, improved gasoline fuel impermeability thereof may be expected, at least, to some extent. NBR/PVC is excellent in waterproof and dust proof properties, also is excellent in low-temperature resistant property, gasoline fuel impermeability, and further in ozone resistant property. NBR is excellent in waterproof and dust proof properties, and further excellent in low-temperature resistant property in spite of low cost. Also, NBR is not inferior even in gasoline fuel impermeability. TPO is excellent in low-temperature resistant property and ozone resistant property as well as waterproof and dust proof properties.

TABLE 1

| | | | | | Water |
|---|---|---|---|---|---|
| | | | Low | | proofness/ |
| | | Gasoline | temperature | Ozone | dust |
| Material | Type | impermeability | resistance | resistance | proofness |
| FKM | fluorine type | ⊚ | X | ⊚ | ◯ |
| (fluoro-rubber) | rubber | | | | |
| NBR | NBR type | | | | |
| (acrylonitrile- | rubber | Δ | ◯ | X | ◯ |
| butadiene | | | | | |
| rubber) | | | | | |
| NBR/PVC | NBR type | | | | |
| (NBR + poly- | rubber | | | | |
| vinyl chloride | | | | | |
| blend rubber) | | | | | |
| FVMQ | silicone type | ◯ ˜ Δ | ⊚ | ⊚ | ◯ |
| (fluoro-silicone- | rubber | | | | |
| rubber) | | | | | |
| EPDM | terpolymer | X | ⊚ | ◯ | ◯ |
| (ethylene- | rubber | | | | |
| propylene- | | | | | |
| diene-rubber) | | | | | |
| TPO | polyolefine | X | ⊚ | ⊚ | ⊚ |
| (thermoplastic | type | | | | |
| olefine) | thermo- | | | | |
| | plastic resin | | | | |

⊚ Superior
⊚ Excellent
Δ Average
X Inferior

In many cases, a resin-bush is fitted in a tubular connector housing to position axially the sealing means therein. Typically, an inner diameter of the resin-bush is dimensioned generally identical to an outer diameter of an inserting end portion of a pipe, and sealing means are provided or disposed in an inner peripheral surface of the tubular connector housing so as to be located on one axial side from the resin-bush. However, if a quick connector is formed small-sized or a portion of the tubular connector housing is formed with short axial length where the sealing means and the resin-bush are to be disposed, room with sufficient axial length cannot be afforded to accommodate the first to the third annular sealing members in properly axially spaced relation with one another on one axial side from the resin-bush. In this case, preferably the third annular sealing member is disposed in the resin-bush fitted in the tubular connector housing on an opposite axial side from the second annular sealing member so as to afford proper space between the annular sealing members. In order to dispose the third annular sealing member in the resin-bush, a seal fitting slot may be formed in the resin-bush and then the third annular sealing member may be fitted in the slot. However, in view of efficiency in quick connector assembly work, it is advantageous that the third annular sealing member is formed integrally in the resin-bush beforehand, for example, by two-color injection molding or two-shot molding. Therefore, material for the third annular sealing member may be suitably selected in view of integrally molding property or adhesion property with respect to the resin-bush, for example, made of polypropylene (PP). TPO may be used for the third annular sealing member due to preferable integral molding property thereof.

A quick connector of the present invention is provided with sealing means of high gasoline fuel impermeability, and thereby serves for reducing gasoline fuel permeation amount from a gasoline fuel piping structure effectively.

Now, the preferred embodiments of the present invention will be described in detail with reference to the drawings.

### BRIEF DESCRIPTION OF THE DRAWINGS

FIG. 1 is a perspective view of a quick connector according to the present invention.

FIG. 2 is a cross-sectional view of the quick connector according to the present invention.

FIG. 3 is a perspective view of a retainer adapted to the quick connector according to the present invention.

FIG. 4 is an enlarged view of a periphery of a second resin bush of the quick connector according to the present invention.

FIG. 5 is a cross-sectional view of the quick connector according to the present invention wherein a pipe is connected.

FIG. 6 is a perspective view of a quick connector of another configuration according to the present invention.

FIG. 7 is a cross-sectional view of the quick connector of another configuration according to the present invention.

FIG. 8 is a perspective view of a retainer adapted to the quick connector of another configuration according to the present invention.

FIG. 9 is a perspective view of a small diameter resin bush adapted to the quick connector of another configuration according to the present invention.

FIG. 10 is a cross-sectional view of the quick connector of another configuration according to the present invention wherein a pipe is connected.

FIG. 11 is a cross-sectional view of a quick connector of the prior art.

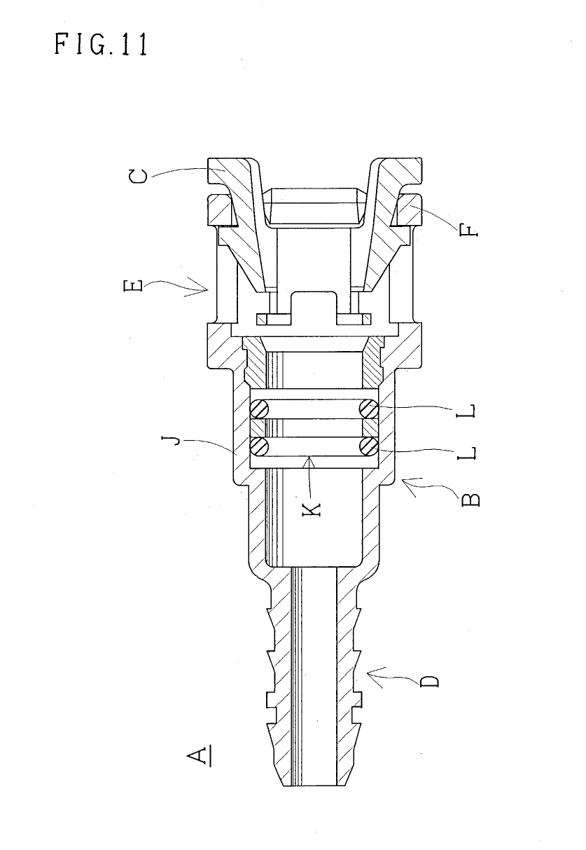

FIG. 12 is a cross-sectional view of the quick connector of the prior art wherein a pipe is connected.

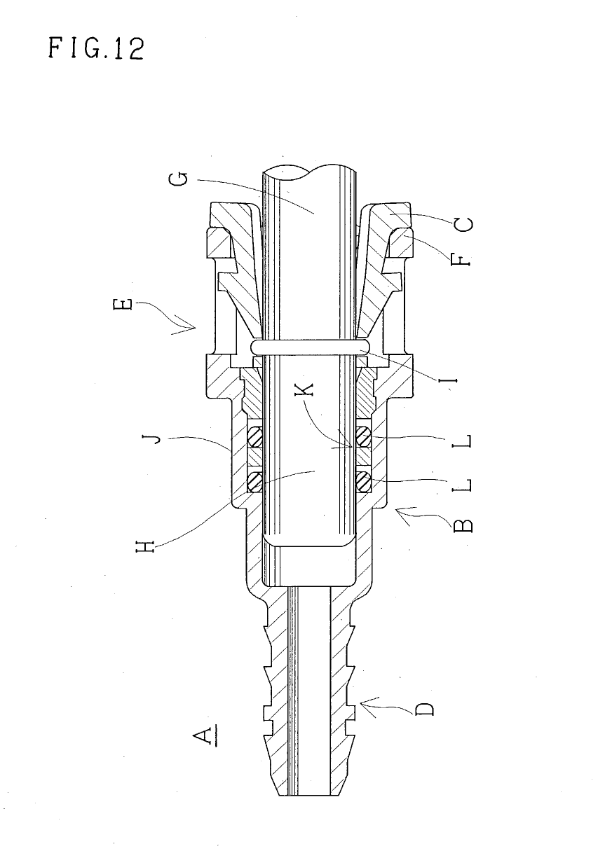

### DETAILED DESCRIPTION OF THE PREFERRED EMBODIMENTS

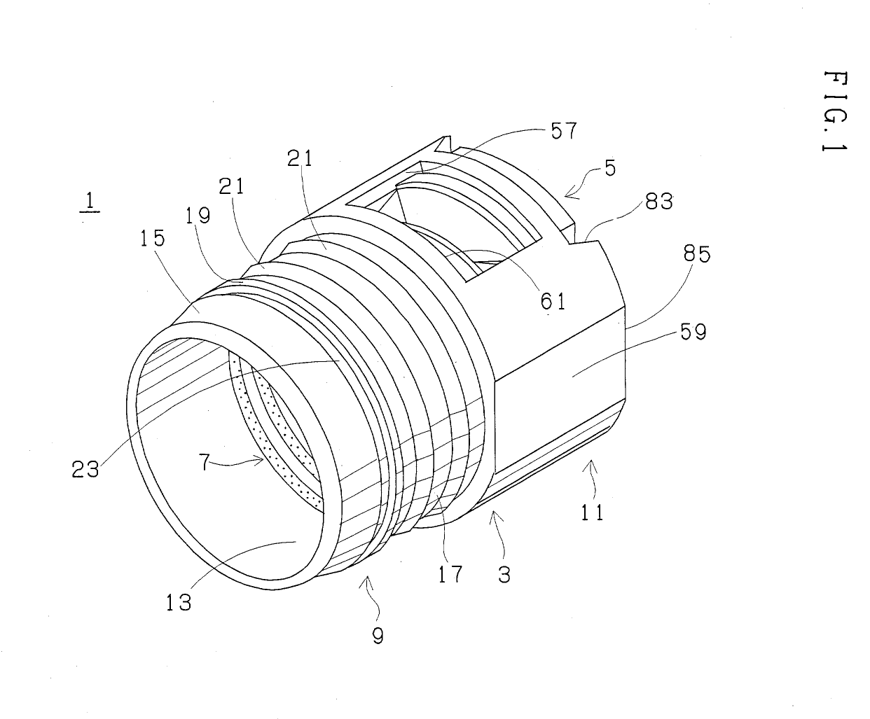

A quick connector 1, which is adapted for assembly for a gasoline fuel piping of an automobile, as shown in FIG. 1, comprises a tubular connector housing 3, a generally annular retainer 5 and sealing means 7. The tubular connector housing 3 made of glass fiber reinforced polyamide (PA.GF), integrally comprises a cylindrical resin tube connecting portion 9 on one axial side thereof and a generally cylindrical projection receiving portion 11 on an opposite axial side thereof, and is provided with a through-bore 13 through from one axial end to an opposite axial end thereof. The resin tube connecting portion 9 comprises one axial side portion 15 like right triangle in cross-section having an outer peripheral surface expanding gently in diameter toward an opposite axial side of the resin tube connecting portion 9, and an opposite axial side portion 17 having an outer peripheral surface extending like a simple cylindrical shape on an opposite axial side from the one axial side portion 15 of the resin tube connecting portion 9. The opposite axial side portion 17 is provided on the outer peripheral surface with an annular projecting stop portion 19 like rectangular in cross-section and two annular projecting stop portions 21, 21 like right triangle in cross-section expanding in diameter toward an opposite axial side thereof. The annular projecting stop portion 19 and the annular projecting stop portions 21, 21 are arranged in axially spaced relation sequentially from one axial side to an opposite axial side of the opposite axial side portion 17. A resin tube, for example a resin pipe member is tightly fitted on and connected to an outer periphery or an outer peripheral surface of the resin tube connecting portion 9. A rubber hose or a SUS pipe is also adapted for member to be connected with a tube connecting portion of a quick connector of the present invention. An outer peripheral surface 23 on one axial end portion of the opposite axial side portion 17, namely a portion between the one axial side portion 15 and the annular projecting stop portion 19 is formed in small diameter or in deep annular groove. Prior to fitting of a resin tube to the quick connector 1, at least one annular sealing member (not shown) is fitted on the outer peripheral surface 23.

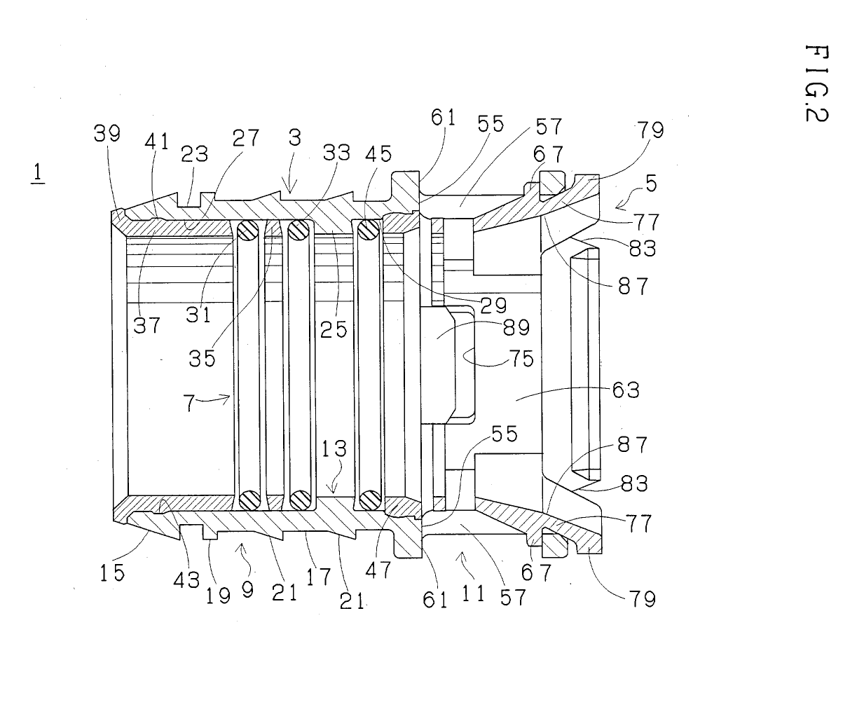

As well shown in FIG. 2, an inner peripheral surface on one axial side from the projection receiving portion 11 or inside of the projection receiving portion 11 of the tubular connector housing 3, or an inner peripheral surface of the tube connecting portion 9 is formed with an inwardly directed annular parting projection 25 near an opposite axial end thereof, and is divided by the inwardly directed annular parting projection 25 into a first receiving portion 27 on one axial side and a second receiving portion 29 on an opposite axial side thereof In the first receiving portion 27, a first O-ring (first annular sealing member) 31 of one axial side and a second O-ring (second annular sealing member) 33 of an opposite axial side are fitted with intervening a collar 35 therebetween, namely in axially spaced relation with one another on an opposite axial side thereof, and a first resin bush 37 is fitted on one axial side thereof. The first resin bush 37 is formed generally in a cylindrical shape, and provided integrally with an annular engagement portion 39 on one axial end portion thereof. The annular engagement portion 39 is formed so as to project somewhat radially outwardly. The first resin bush 37 is provided with a low annular projecting portion 41 on an outer peripheral surface near one axial end thereof, and has an inner diameter substantially identical to an inner diameter of the inwardly directed annular parting projection 25. However, the annular engagement portion 39 has an inner peripheral surface expanding in diameter toward one axial side thereof. Thus configured first resin bush 37 is fitted in the first receiving portion 27 so that the annular projecting portion 41 seats in a shallow annular groove 43 formed near one axial end of the first receiving portion 27 and an outer peripheral surface of an opposite axial side of the annular engagement portion 39 engages with one axial end portion of the tube connecting portion 9 or the one axial side portion 15. An outer peripheral surface of one axial side of the annular engagement portion 39 is located so as to be substantially continued from an outer peripheral surface of the one axial side portion 15, just like an tapered outer peripheral surface of the one axial side portion 15 extended in one axial direction. The first O-ring 31 and the second O-ring 33 are maintained in an axial position, between the inwardly directed annular parting projection 25 and the first resin bush 37.

The first O-ring 31 is made of FKM and the second O-ring 33 is also made of FKM. The collar 35 is formed of trapezoid tapered in a radially outward direction in cross-section so as to provide a room as escapeway for the first and the second O-rings 31, 33 which are axially swollen when pressed by a pipe. With adapting thus configured sealing structure, it is effectively prevented that the first O-ring 31 and the second O-ring 33 are unacceptably deformed at insertion of a pipe, although they are formed relatively in large diameter and are apt to be deformed.

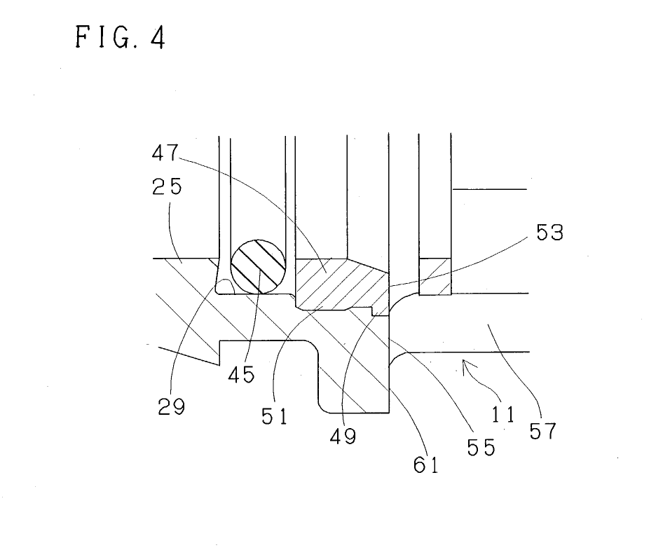

As well shown in FIG. 4, in the second receiving portion 29, a third O-ring (third annular sealing member) 45 is fitted on one axial side, and a second resin bush 47 of annular shape is fitted on an opposite axial side thereof. The second resin bush 47 integrally has a flange 49 projecting somewhat radially outwardly on an opposite axial end portion thereof, and is provided with an annular projecting portion 51 swelling somewhat radially outwardly on an outer peripheral surface of one axial side thereof. An inner peripheral surface of the second resin bush 47 comprises an opposite axial side surface portion expanding in diameter toward an opposite axial side or in an opposite axial direction and one axial side surface portion extending like a short cylindrical shape with an inner diameter generally identical to an inner diameter of the inwardly directed annular parting projection 25. An opposite axial side portion of the second receiving portion 29 is formed somewhat large in diameter and corresponds to an outer peripheral surface of the second resin bush 47 in shape. The second resin bush 47 is fitted in an opposite axial side portion of the second receiving portion 29 so that an annular end surface 53 on an opposite axial side thereof is located to share a plane common with an annular abutment surface or an annular inside end surface 55 formed on one axial end of inner side of the projection receiving portion 11 with narrow width extending radially inwardly. The third O-ring 45 is maintained in an axial position, between the inwardly directed annular parting projection 25 and the second resin bush 47. As an opposite axial end surface of the inwardly directed annular parting projection 25 is formed toward radially outwardly inclining in one axial direction so as to provide a room as escapeway for the third O-ring 45 which is axially swollen when pressed by a pipe. With adapting thus configured sealing structure, it is effectively prevented that the third O-ring 45 is unacceptably deformed at insertion of a pipe, although the third O-ring 45 is formed relatively in large diameter, and is apt to be deformed.

The third O-ring 45 is typically made of FKM, and may be made of FVMQ, NBR, NBR/PVC, EPDM or TPO.

The first O-ring 31, the second O-ring 33 and the third O-ring 45 construct sealing means 7. In this sealing means 7, an axial space generally corresponding to thickness of the collar 35 is secured between the first O-ring 31 and the second O-ring 33, while an axial space generally corresponding to thickness of the inwardly directed annular parting projection 25 is secured between the second O-ring 33 and the third O-ring 45. The collar 35 is thinner than the inwardly directed annular parting projection 25, specifically, generally of one-half thickness of the inwardly directed annular parting projection 25. Therefore, the axial space secured between the first O-ring 31 and the second O-ring 33 is shorter than the axial space secured between the second O-ring 33 and the third O-ring 45, specifically, generally of one-half length of the axial space between the second O-ring 33 and the third O-ring 45.

The generally cylindrical projection receiving portion 11 of larger diameter than the resin tube connecting portion 9, is provided with engagement windows 57, 57 in diametrically symmetrical positions and in opposed relation with one another, and flat regions 59, 59 (only one flat region 59 is shown) on the outer peripheral surfaces respectively between the engagement windows 57, 57. One axial ends or one axial end surfaces 61, 61 of the engagement windows 57, 57 are located to share a plane common with the annular abutment surface 55 of inner side of the projection receiving portion 11 and the annular end surface 53 of an opposite axial side of the second resin bush 47. That is, no step is defined on a surface between the one axial end 61 of the engagement window 57 and an edge of an opening of an opposite axial side of the second resin bush 47 or the annular end surface 53 of the second resin bush 47, and this configuration hardly permits water to remain there. Thereby such inconvenience is eliminated as water remains in a gap defined between a step and a metallic pipe connected resulting that the pipe is rusted and corroded. When a checker for verifying complete connection with a pipe is adapted, typically, engagement portions of the checker engage with the engagement windows 57, 57.

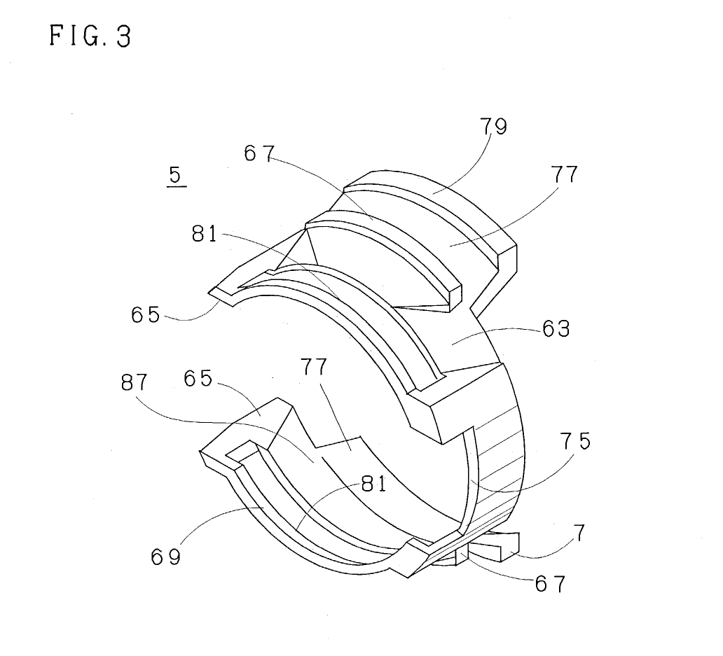

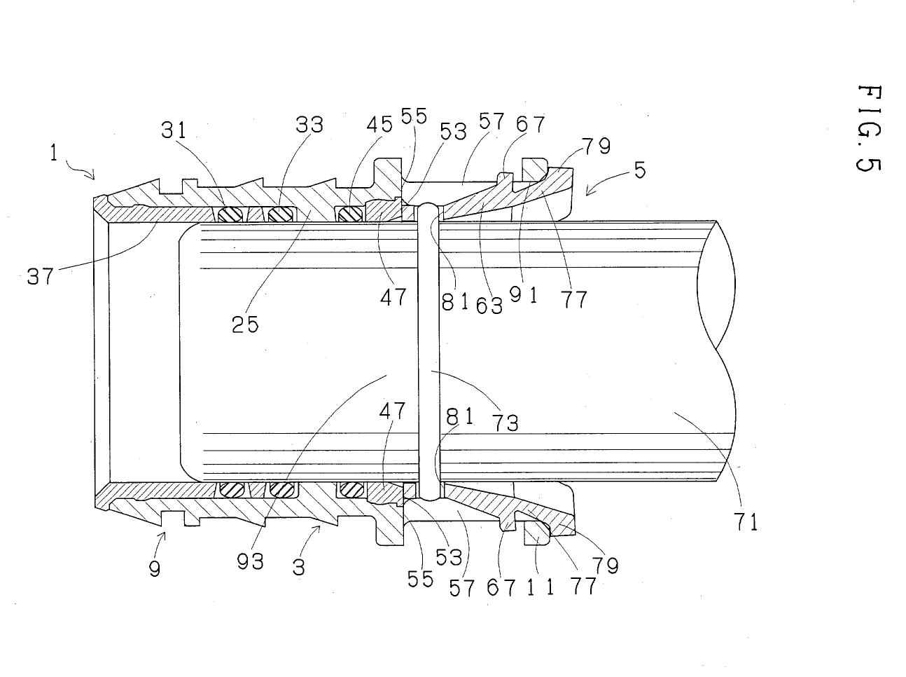

The retainer 5 made of PA is fitted in the projection receiving portion 11. This retainer 5 is relatively flexible, and is formed so as to be resiliently deformable. As well shown in FIG. 3, the retainer 5 has a main body 63 of C-shape in cross-section, namely generally annular shape wherein a relatively large space for deformation is defined between circumferential opposite ends 65, 65 thereof. The main body 63 is provided with a pair of engagement tabs 67, 67 projecting radially outwardly in diametrically symmetrical positions of an opposite axial end portion thereof. An inner surface of the main body 63, except a portion diametrically opposed to the space for deformation, is tapered so as to reduce gradually an inner diameter thereof toward one axial side or in one axial direction. And, apart from a portion diametrically opposed to the space for deformation, one axial end portion 69 of the main body 63 is formed with an inner diameter almost identical to a pipe (refer to a reference numeral 71 in FIG. 5), and smaller than an annular engagement projection (refer to a reference numeral 73 in FIG. 5). The portion diametrically opposed to the space for deformation of the main body 63 has an inner surface shaped like a part of a cylindrical inner surface, and is formed with a notched portion 75 on one axial end portion 69 thereof.

A pair of short operation arms 77, 77 are formed integrally on an opposite axial end portion of the main body 63 of the retainer 5 so as to extend inclining radially outwardly in an opposite axial direction from respective circumferential positions corresponding to the engagement tabs 67, 67. The operation arm 77 respectively, has a latching end 79 projecting radially outwardly on an opposite axial end portion thereof. The one axial end portion 69 of the main body 63 is provided with engagement slits 81, 81 extending circumferentially in opposed relation with one another. Thus configured retainer 5 is inserted and fitted in the projection receiving portion 11 so that the engagement tabs 67, 67 seat in the engagement windows 57, 57 of the projection receiving portion 11 and the latching ends 79, 79 fit in recessed receiving portions 83, 83 of the projection receiving portion 11 in engagement relation therewith respectively. The recessed receiving portions 83, 83 are formed in diametrically symmetrical positions of the opposite axial end portion 85 of the projection receiving portion 11 respectively. As the latching end 79 of the operation arm 77 is received in thus arranged recessed receiving portion 83, it is prevented that the retainer 5 moves from its correct fit-in position in the projection receiving portion 11, when the latching end 79 is just touched carelessly by an operator. The recessed receiving portions 83, 83 have circumferential opposite ends widening in an opposite axial direction. Opposed inner surface 87, 87 of the retainer 5 in arcuate cross-section which extend from the operation arms 77, 77 to the engagement slits 81, 81 are generally tapered respectively in one axial direction toward the center or the central axis of the retainer 5. And then the retainer 5 is configured so that the annular engagement projection 73 of the pipe 71 necessarily or substantially necessarily abuts the tapered inner surfaces 87, 87 of the retainer 5 at boundaries between the operation arms 77, 77 and the main body 63 when the pipe 71 is inserted in the main body 63 of the retainer 5 from the side of the latching ends 79, 79 of the operation arms 77, 77. Reference numeral 89 in FIG. 2 indicates an anti-rotation raised portion is formed integrally on an inner peripheral surface of the projection receiving potion 11 and fits in the notched portion 75 of the main body 63 of the retainer 5 to restrain rotational movement with respect to the retainer 5.

As shown in FIG. 5, the pipe 71 to be joined with the tube, made of metal is inserted in the quick connector 1 from an insertion opening 91 on an opposite axial end of the projection receiving portion 11, more specifically, in the main body 63 of the retainer 5 from the side of the latching ends 79, 79 of the operation arms 77, 77, and is to be fitted in the quick connector 1. The pipe 71 has an inserting end portion 93 on one axial side wherein the annular engagement projection 73 is formed on an outer peripheral surface. The pipe 71 is pushed, and fittingly inserted into the quick connector 1 or the tubular connector housing 3 so that the annular engagement projection 73 progresses radially expanding an inner surface of the main body 63 of the retainer 5 until the annular engagement projection 73 seats in the engagement slits 81, 81 in snap-engagement relation therewith. The annular engagement projection 73 which has seated and snap-engaged in the engagement slits 81, 81 of the main body 63 of the retainer 5 blocks or limits further axial in-and-out movement of the pipe 71 with respect to the quick connector 1. That is, the pipe 71 is thereby almost locked against relative axial movement in the quick connector 1. One axial end or an inserting end of the pipe 71 reaches in the first resin bush 37 fitted in the resin tube connecting portion 9 through the third O-ring 45, the second O-ring 33 and the first O-ring 31, and thereby a seal is formed by the first to the third O-rings 31, 33, 45 between an outer peripheral surface of the pipe 71 and an inner peripheral surface of the quick connector 1, more specifically, between an outer peripheral surface of one axial side from the annular engagement projection 73 of the inserting end portion 93 of the pipe 71 and an inner peripheral surface of the tube connecting portion 9. An one axial side from the annular engagement projection 73 of the inserting end portion 93 of the pipe 71 is fittingly inserted without play in the second resin bush 47, the inwardly directed annular parting projection 25 and the first resin bush 37 having inner diameters identical to an outer diameter of the pipe inserting portion 93 of the pipe 71. The retainer 5 is usually fitted slightly loosely in the projection receiving portion 11 with slight axial play therein. However, at least when the pipe 71 is fully inserted therein, one axial end of the main body 63 is in abutment relation relative to the annular abutment surface 55 and the annular end surface 53 of an opposite axial side of the second resin bush 47.

In the event of removing the pipe 71 from the quick connector 1, the latching ends 79, 79 of the operation arms 77, 77 received in the recessed receiving portions 83, 83 are pressed radially inwardly from outside to narrow a radial space between the operation arms 77, 77, thus a radial space between the engagement tabs 67, 67. And, thereby the engagement tabs 67, 67 are out of the engagement windows 57, 57, and the retainer 5 can be relatively pulled out of the tubular connector housing 3. As the retainer 5 is relatively pulled out of the tubular connector housing 3, the pipe 71 will have been also pulled out of the quick connector 1 or the tubular connector housing 3 along with the retainer 5.

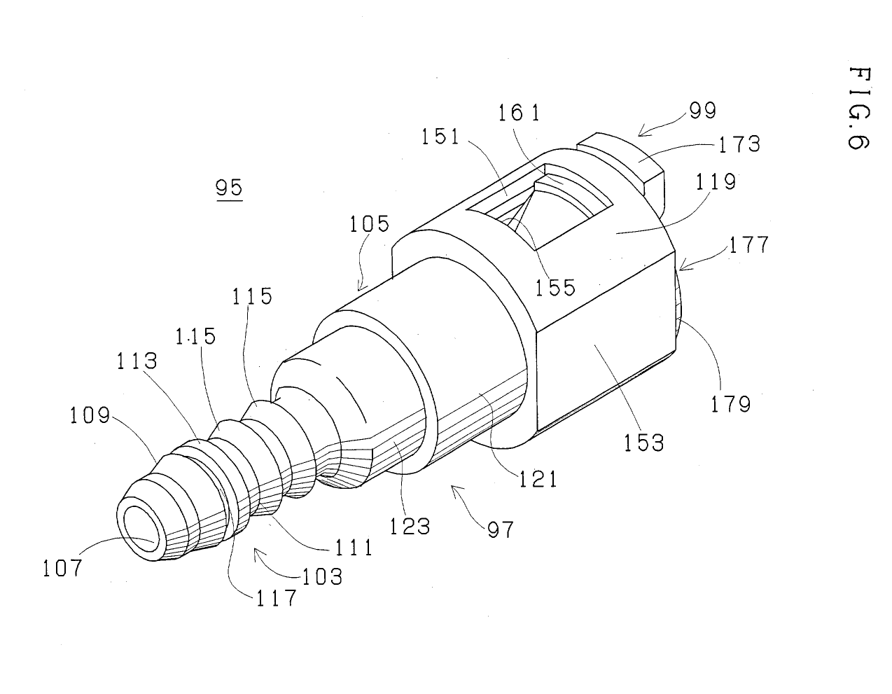

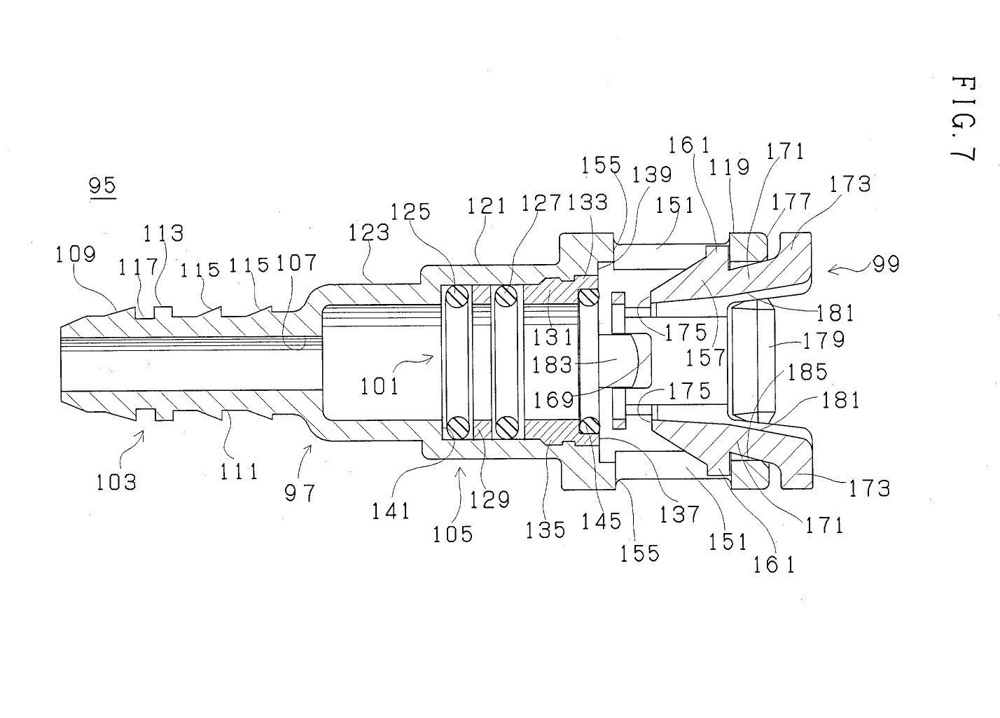

FIGS. 6 and 7 show a quick connector 95 of another configuration. The quick connector 95 of another configuration, which is also adapted for assembly in a gasoline fuel piping of an automobile, comprises a tubular connector housing 97, a generally annular retainer 99 and sealing means 101 just like the quick connector 1, but is formed small-sized or smaller in diameter than the quick connector 1. The tubular connector housing 97 made of PA.GF, integrally comprises a cylindrical resin tube connecting portion 103 on one axial side thereof and a generally cylindrical pipe inserting portion 105 on an opposite axial side thereof, and is provided with a through-bore 107 through from one axial end to an opposite axial end thereof. The resin tube connecting portion 103 comprises one axial side portion 109 having an outer peripheral surface generally expanding gently in diameter toward an opposite axial side and formed like right triangle in cross-section on an opposite axial side thereof, and an opposite axial side portion 111 having an outer peripheral surface extending like a simple cylindrical shape on an opposite axial side from the one axial side portion 109. The opposite axial side portion 111 is provided on an outer peripheral surface with an annular projecting stop portion 113 like rectangular in cross-section and two annular projecting stop portions 115, 115 like right triangle in cross-section expanding in diameter toward an opposite axial side thereof. The annular projecting stop portion 113 and the annular projecting stop portions 115, 115 are arranged in axially spaced relation sequentially from one axial side to an opposite axial side of the opposite axial side portion 111. A resin tube is tightly fitted on an outer periphery or an outer peripheral surface of the resin tube connecting portion 103 and connected thereto. An outer peripheral surface 117 on one axial end portion of the opposite axial side portion 111, namely a portion between the one axial side portion 109 and the annular projecting stop portion 113 is formed in small diameter or in deep annular groove. Prior to fitting of a resin tube to the quick connector 95, at least one annular sealing member (not shown) is provided on the outer peripheral surface 117.

As well shown in FIG. 7, the pipe inserting portion 105 of the tubular connector housing 97 integrally comprises a large diameter projection receiving portion 119 on an opposite axial side, a seal holding portion 121 axially in the middle and a link portion 123 on one axial side thereof. The seal holding portion 121 is formed smaller in diameter than the projection receiving portion 119, and the link portion 123 is formed smaller in diameter than the seal holding portion 121. In the seal holding portion 121, a first O-ring (first annular sealing member) 125 of one axial side and a second O-ring (second annular sealing member) 127 of an opposite axial side are fitted on one axial side of an inner peripheral surface with intervening a collar 129 therebetween, in axially spaced and side by side relation with one another, and a small diameter resin bush (resin-bush) 131 is fitted on an opposite axial side thereof. The small diameter resin bush or the resin bush 131 is formed in a short tubular shape with an inner diameter generally identical to that of the link portion 123. The small diameter resin bush 131 is provided integrally with annular projections 133, 135 projecting somewhat radially outwardly on an opposite axial end portion and an axially middle portion of an outer peripheral surface respectively. An opposite axial side portion of an inner peripheral surface of the seal holding portion 121 is formed so as to correspond to an outer peripheral surface of the small diameter resin bush 131 in shape. The small diameter resin bush 131 is fitted in an opposite axial side portion of the seal holding portion 121 so that an annular end surface 137 on an opposite axial side is located to share a plane common with an annular abutment surface or an annular inside end surface 139 with narrow width formed on one axial end of inner side of the projection receiving portion 119 and expanding inwardly. The first O-ring 125 and the second O-ring 127 are maintained in an axial position, between an annular stepped surface 141 formed on one axial end of inner side of the seal holding portion 121 and the small diameter resin bush 131.

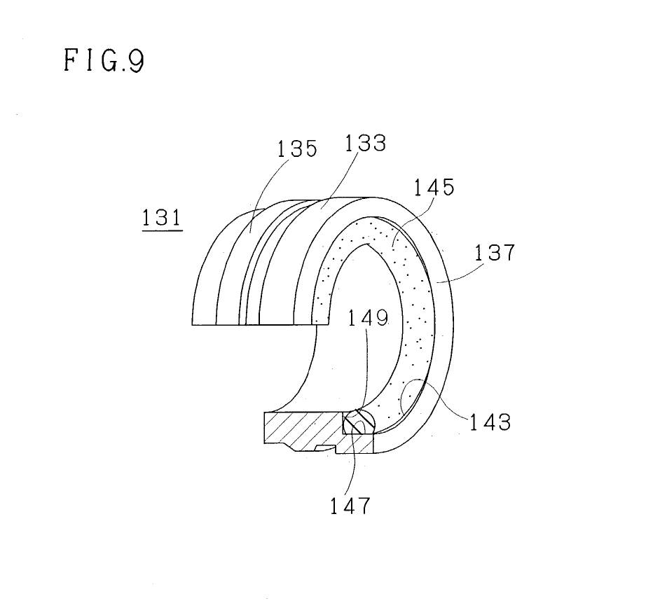

As well shown in FIG. 9, the annular end surface 137 on an opposite axial side of the small diameter resin bush 131 is formed with an annular recessed portion 143 on an inner peripheral portion. In the annular recessed portion 143, namely in a large diameter portion formed short internally on an opposite axial end portion of the small diameter resin bush 131, a third O-ring or a third sealing ring (a third annular sealing member) 145 is received. The third O-ring 145 is formed like semicircle in cross-section so as to locate a cutting line of the semi-circle in cross-section or a flat side surface on an outer peripheral side. The third O-ring 145 is adhered to an annular peripheral surface 147 of the annular recessed portion 143 with an outer peripheral surface thereof. A diameter in cross-section or a cross-sectional diameter of the third O-ring 145 is dimensioned generally identical to an axial length of the annular peripheral surface 147, namely depth from the annular end surface 137 on an opposite axial side of the small diameter resin bush 131 to an annular bottom surface 149 of the annular recessed portion 143. The third O-ring 145 is received in the annular recessed portion 143 so that an axial position of an opposite axial end thereof generally corresponds to that of the annular end surface 137 of an opposite axial side of the small diameter resin bush 131. Prior to fitting the small diameter resin bush 131 in the seal holding portion 121, the third O-ring 145 is accommodated and secured in the small diameter resin bush 131. The small diameter resin bush 131 with the third O-ring 145 may be easily produced by two-color injection molding or two-shot molding, or insert molding at molding of the small diameter resin bush 131. That is, the third O-ring 145 is formed integrally in the small diameter resin bush 131 by two-color injection molding or two-shot molding, or insert molding. Here, the small diameter resin bush 131 is formed integrally with the third O-ring 145 therein.

The first O-ring 125 is made of FKM, and the second O-ring 127 is also made of FKM. The third O-ring 145 is also made of FKM, but may be made of FVMQ, NBR, NBR/PVC, EPDM or TPO. For the small diameter resin bush 131, thermoplastic resin such as PP or thermoplastic resin reinforced by glass fiber or the like are used. In view of adhesion property with these resins at two-color injection molding or two-shot molding, or insert molding, it is effective to adapt TPO for the third O-ring 145.

The first O-ring 125, the second O-ring 127 and the third O-ring 145 construct sealing means 101. An axial space generally corresponding to thickness of the collar 129 is secured between the first O-ring 125 and the second O-ring 127, while an axial space generally corresponding to an axial distance from one axial end of the small diameter resin bush 131 to the annular recessed portion 143 is secured between the second O-ring 127 and the third O-ring 145. Thickness of the collar 129 is smaller than an axial distance from one axial end of the small diameter resin bush 131 to the annular recessed portion 143, specifically generally one-third of an axial space from an one axial end of the small diameter resin bush 131 to the annular recessed portion 143. Therefore, an axial space secured between the first O-ring 125 and the second O-ring 127 is smaller than an axial space secured between the second O-ring 127 and the third O-ring 145, specifically, generally one-third of axial space secured between the second O-ring 127 and the third O-ring 145.

The generally cylindrical projection receiving portion 119 of the pipe inserting portion 105 is formed smaller in diameter, but larger in proportion of axial length to the diameter, compared to the projection receiving portion 11 of the quick connector 1. The projection receiving portion 119 is, just like the projection receiving portion 11, provided with engagement windows 151, 151 in diametrically symmetrical positions and in opposed relation with one another, and flat regions 153, 153 (only one flat region 153 is shown) on the outer peripheral surfaces respectively in diametrically symmetrical positions between the engagement windows 151, 151. One axial ends or one axial end surfaces 155, 155 of the engagement windows 151, 151 are located on an opposite axial side from the annular abutment surface 139 of inner side of the projection receiving portion 119 and the annular end surface 137 on an opposite axial side of the small diameter resin bush 131. A stepped portion is defined between one axial ends 155, 155 of the engagement windows 151, 151, and the annular abutment surface 139 of inner side of the projection receiving portion 119 and the annular end surface 137 of an opposite axial side of the small diameter resin bush 131. When a checker for verifying complete connection with a pipe is adapted, typically, engagement portions of the checker engage with the engagement windows 151, 151.

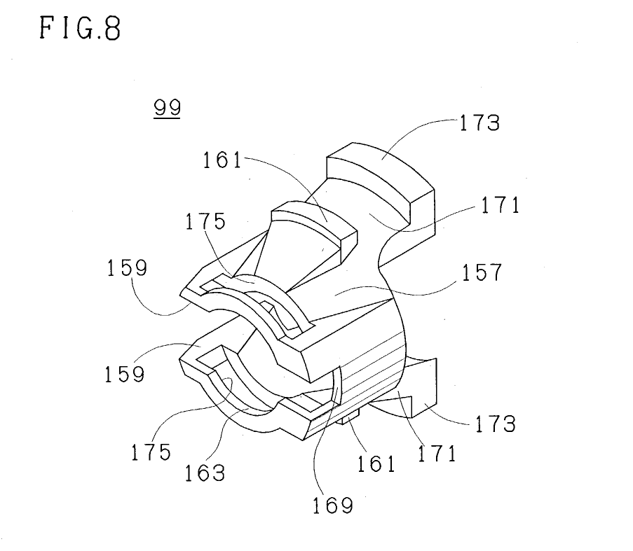

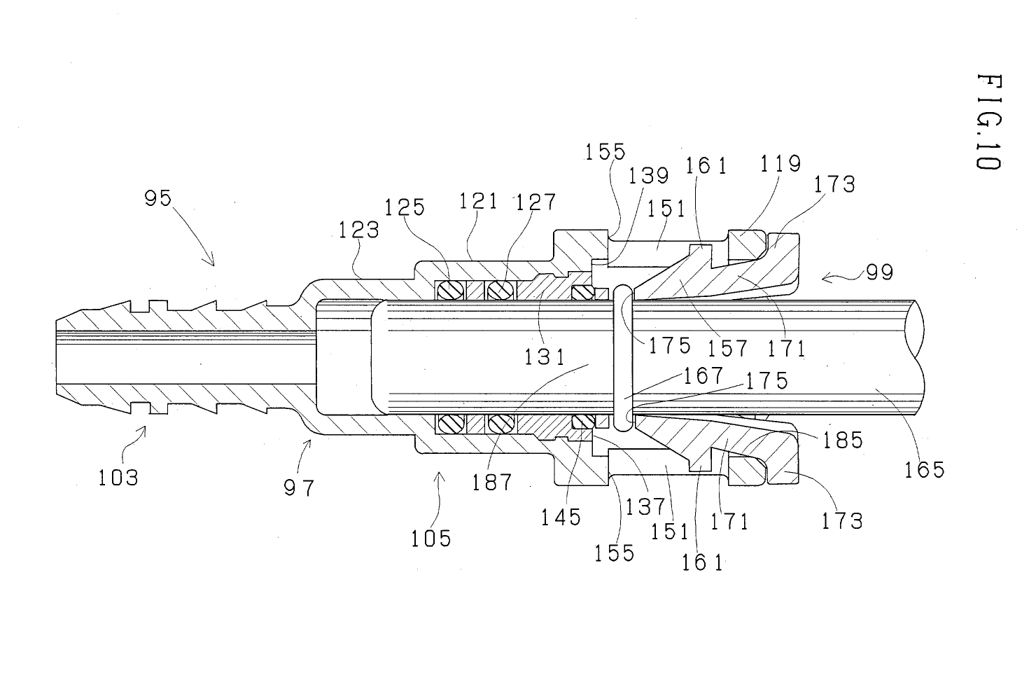

The retainer 99 made of PA is fitted in the projection receiving portion 119. As well shown in FIG. 8, this retainer 99 is, just like the retainer 5 of the quick connector 1, relatively flexible, and is formed so as to be resiliently deformable. The retainer 99 is formed corresponding to a shape of the projection receiving portion 119, smaller in diameter, but larger in a proportion of an axial length to a diameter compared to the retainer 5. The retainer 99 has a main body 157 of C-shape in cross-section, namely generally annular shape wherein a relatively large space for deformation is defined between circumferential opposite ends 159, 159 thereof. The main body 157 is provided with a pair of engagement tabs 161, 161 projecting radially outwardly in diametrically symmetrical positions on an opposite axial end portion thereof. An inner surface of the main body 157, except a portion diametrically opposed to the space for deformation, is tapered generally so as to reduce gradually an inner diameter thereof toward one axial side or in one axial direction. And, apart from a portion diametrically opposed to the space for deformation, one axial end portion 163 of the main body 157 is formed with an inner diameter almost identical to a pipe (refer to a reference numeral 165 in FIG. 10), and smaller than an annular engagement projection (refer to a reference numeral 167 in FIG. 10). The portion diametrically opposed to the space for deformation of the main body 157 has an inner surface shaped like a part of a cylindrical inner surface, and is formed with a notched portion 169 on one axial end portion 163 thereof.

A pair of relatively long operation arms 171, 171 are formed integrally on an opposite axial end portion of the main body 157 of the retainer 99 so as to extend inclining radially outwardly toward an opposite axial side or in an opposite axial direction from respective circumferential positions corresponding to the engagement tabs 161, 161. The operation arm 171 respectively, has a latching end 173 projecting radially outwardly on an opposite axial end portion thereof. The one axial end portion 163 of the main body 157 is provided with engagement slits 175, 175 extending circumferentially in opposed relation with one another. Thus configured retainer 99 is inserted and fitted in the projection receiving portion 119 so that the engagement tabs 161, 161 seat in the engagement windows 151, 151 of the projection receiving portion 119 and the latching ends 173, 173 engage with an opposite axial end 177 of the projection receiving portion 119. Axial projections 179, 179 are formed on an opposite axial end surface of the projection receiving portion 119 in circumferential positions corresponding to the flat regions 153, 153. The axial projections 179, 179 function to restrain rotational movement with respect to the latching ends 173, 173 of the operation arms 171, 171, therefore with respect to the retainer 99. Inner surfaces 181, 181 in arcuate cross-section of the retainer 99 in opposed relation with one another, extending from the operation arms 171, 171 to the engagement slits 175, 175, are generally tapered respectively in one axial direction toward the center or the central axis of the retainer 99. When the pipe 165 is inserted in the main body 157 of the retainer 99 from side of the latching ends 173, 173 of the operation arms 171, 171, the annular engagement projection 167 of the pipe 165 necessarily or substantially necessarily abuts tapered inner surfaces 181, 181 of the retainer 99 at boundaries between the operation arms 171, 171 and the main body 157. Reference numeral 183 in FIG. 7 indicates an anti-rotation raised portion is formed integrally on an inner peripheral surface of the projection receiving potion 119 and fits in the notched portion 169 of the main body 157 of the retainer 99 to restrain rotational movement with respect to the retainer 99.

As shown in FIG. 10, the pipe 165 to be joined with the tube, made of metal, is inserted in the quick connector 95 from an insertion opening 185 on an opposite axial end of the projection receiving portion 119, more specifically, in the main body 157 of the retainer 99 from a side of the latching ends 173, 173 of the operation arms 171, 171, and is to be fitted in the quick connector 95. Just like the pipe 71, the pipe 165 has an inserting end portion 187 on one axial side thereof wherein the annular engagement projection 167 is formed on an outer peripheral surface, but is dimensioned smaller in diameter than the pipe 71 so as to correspond to a dimension of the quick connector 95. The pipe 165 is pushed and fittingly inserted into the quick connector 95 or the tubular connector housing 97 so that the annular engagement projection 167 progresses radially expanding an inner surface of the main body 157 of the retainer 99 until the annular engagement projection 167 seats in the engagement slits 175, 175 in snap-engagement relation therewith. The annular engagement projection 167 which has fitted and snap-engaged in the engagement slits 175, 175 of the main body 157 of the retainer 99 blocks or limits further axial in-and-out movement of the pipe 165 with respect to the quick connector 95. That is, the pipe 165 is thereby almost locked against relative axial movement in the quick connector 95. One axial end or inserting end of the pipe 165 reaches in the link portion 123 through the third O-ring 145, the second O-ring 127 and the first O-rings 125 and thereby a seal is formed by the first to the third O-rings 145, 127 and 125 between an outer peripheral surface of the pipe 165 and an inner peripheral surface of the quick connector 95, more specifically, between an outer peripheral surface of one axial side from the annular engagement projection 167 of the inserting end portion 187 of the pipe 165 and an inner peripheral surface of the seal holding portion 121. An one axial side from the annular engagement projection 167 of the inserting end portion 187 of the pipe 165 is fittingly inserted without play in the small diameter resin bush 131 and the link portion 123 having an inner diameter generally identical to an outer diameter of the inserting end portion 187 of the pipe 165. The retainer 99 is usually fitted slightly loosely in the projection receiving portion 119 with slight axial play therein. However, at least when the pipe 165 is fully inserted therein, one axial end of the main body 157 is in abutment relation with respect to the annular abutment surface 139 and the annular end surface 137 of an opposite axial side of the small diameter resin bush 131. As a step is defined between one axial ends 155, 155 of the engagement windows 151, 151, and the annular abutment surface 139 and the annular end surface 137 on an opposite axial side of the small diameter resin bush 131, the engagement slits 175, 175 of the retainer 99 are shown in the engagement windows 151, 151 adjacent to one axial ends 155, 155, of the engagement windows 151, 151, when one axial end of the main body 157 is in abutment relation with the annular abutment surface 139 and the annular end surface 137 on an opposite axial side of the small diameter resin bush 131.

In the event of removing the pipe 165 from the quick connector 95, the latching ends 173, 173 of the operation arms 171, 171 engaging with the opposite axial end portions 177 of the projection receiving portion 119 are pressed radially inwardly from outside to narrow a radial space between the operation arms 171, 171, thus a radial space between the engagement tabs 161, 161. And, thereby the engagement tabs 161, 161 are out of the engagement windows 151, 151 and the retainer 99 can be relatively pulled out of the tubular connector housing 97. As the retainer 99 is relatively pulled out of the tubular connector housing 97, the pipe 165 will have been also pulled out of the quick connector 95 or the tubular connector housing 97 along with the retainer 99.

We claim:

1. A quick connector for gasoline fuel path to be connected with a pipe including an inserting end portion provided with an annular engagement projection, comprising:
a tubular connector housing provided with a tube connecting portion on one axial side thereof and a projection receiving portion to receive the annular engagement projection of the pipe on an opposite axial side thereof,
retainer means provided for the projection receiving portion and configured so as to snap-engage with the annular engagement projection of the pipe when the inserting end potion of the pipe is inserted in the tubular connector housing from an insertion opening on an opposite axial end of the projection receiving portion.
sealing means disposed on one axial side from the projection receiving portion in the tubular connector housing to provide a seal between the tubular connector housing and one axial side from the annular engagement projection of the inserting end portion provided on the pipe, the sealing means including a first annular sealing member made of FKM and a second annular sealing member also made of FKM located on an opposite axial side from the first annular sealing member, and the first annular sealing member and the second annular sealing member being disposed properly axially spaced relation with one another in the tubular connector housing.

2. The quick connector as set forth in claim 1 wherein the sealing means further includes a third annular sealing member located on an opposite axial side from the second annular sealing member and the third annular sealing member is disposed properly axially spaced with respect to the second annular sealing member in the tubular connector housing.

3. The quick connector as set forth in claim 2 wherein the third sealing member is made of FKM.

4. The quick connector as set forth in claim 2 wherein the third sealing member is made of elastic material of low-temperature resistant property.

5. The quick connector as set forth in claim 4 wherein the elastic material of low-temperature resistant property for the third sealing member is selected from the group consisting of FVMQ, NBR, NBR/PVC, EPDM and TPO.

6. The quick connector as set forth in claim 2 wherein a resin-bush is fitted on an opposite axial side from the second annular sealing member in the tubular connector housing, the resin-bush has an inner diameter generally identical to an outer diameter of the inserting end portion of the pipe, and the third annular sealing member is provided in the resin-bush to be disposed in the tubular connector housing.

7. The quick connector as set forth in claim 6 wherein the third annular sealing member is formed integrally in and provided in the resin-bush beforehand, and is disposed in the tubular connector housing along with the resin-bush fitted in the tubular connector housing.
